(19) United States
(12) Patent Application Publication
(10) Pub. No.: US 2008/0168081 A1
(43) Pub. Date: Jul. 10, 2008

(54) EXTENSIBLE SCHEMAS AND PARTY CONFIGURATIONS FOR EDI DOCUMENT GENERATION OR VALIDATION

(75) Inventors: Suraj Gaurav, Issaquah, WA (US); Surendra Machiraju, Issaquah, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/621,362

(22) Filed: Jan. 9, 2007

(51) Int. Cl. G06F 17/30

(52) U.S. Cl. 707/102; 707/100; 707/E17.005

(57) ABSTRACT

Improved systems for EDI schema generation or EDI document formation are provided based on extensible EDI schema, enhancing design time tools. Automatic schema discovery is performed based on deployed schemas for transaction sets within an EDI document. Instance generation and validation are also customizable to synchronize with per party EDI Properties enabling fine control over various choices for generation or validation processes.

### TECHNICAL FIELD

The subject disclosure generally relates to generating and/or validating EDI documents in an EDI system.

### BACKGROUND

Electronic Data Interchange (EDI) standards have empowered organizations to send virtually limitless kinds of structured messages to one another to facilitate the communication of any kind of business data from one organization to another in automated ways. Once an EDI system is setup properly, EDI messages can be used to automate a variety of communications to and from partners, business sub-units, sellers, buyers, etc., thereby substantially reducing the overhead associated with filling out paper forms, storing volumes of papers, etc. With EDI, for instance, an organization merely fills out an electronic form, which creates an EDI document in a manner conforming to a pre-defined schema, and then the messaging, storage/record keeping and validation of the message(s) associated with the electronic form occurs automatically.

EDI messages thus have an associated EDI schema, also called a transaction set definition (TSD), which instructs an EDI system how to interpret a given EDI message instance, i.e., how to validate an EDI message has been structured correctly and with appropriate information. In this regard, there are thousands of EDI message types. For instance, when an EDI message of a particular type, e.g., a purchase order, is created by an EDI system, the EDI message is created in a way that conforms to the purchase order schema. For another EDI message, another schema will be implicated, and so on for hundreds, thousands, or hundreds of thousands EDI messages generated by an EDI system.

Moreover, EDI supports the processing of multiple transaction sets simultaneously via an Interchange, which is a kind of ‘carton’ for EDI messages, which may include numerous transaction sets of a variety of types. In such a case, an Interchange schema is correspondingly a complex document that must cover all of the cases for the TSDs for the different transaction sets of the Interchange.

On the flip side of generating EDI documents in an EDI system is using EDI schemas to validate EDI documents received from another EDI system, e.g., validating EDI documents generated by a third party EDI system. Thus, EDI schemas or TSDs are also used to confirm that EDI documents conform to structure and rules defined by a relevant schema or TSD. In such case, typically, an administrator of the receiving EDI system will create a custom EDI schema handcrafted for the relationship. In this respect, the receiving EDI system is generally in the best position to set rules for when transaction sets of a third party EDI document is valid for its requirements.

As a result, to make an appropriate EDI schema, today an expert of the receiving EDI system well versed in the esotericisms of EDI data structures will generate a schema for validation of EDI documents from a particular third party. Typically, this is done based on a sample EDI document provided by the third party. However, as shown by FIG. 16A, for a non-trivial or otherwise complex EDI document, numerous Transaction Sets 1600a, 1600b, 1600c, . . . , 1600N-1, 1600N may be included in a sample EDI document 1600 provided. Creating a corresponding schema 1610 thus involves defining TSDs for handling every possible combination of those Transaction Sets 1600a, 1600b, 1600c, . . . , 1600N-1, 1600N, which implicates N factorial (N!) groupings of Transaction Sets 1600a, 1600b, 1600c, . . . , 1600N-1, 1600N, introducing a significant setup cost to generating a schema for validating documents based on the sample EDI document 1600.

Today, any of extensible markup language (XML) Schema Definitions (XSDs), external data representations (XDRs), document type definitions (DTDs) or rules in a database are used to represent schemas for EDI messages. In this regard, XSDs, XDRs, DTDs and rules in a database are schema files that can be created to describe the schema for a particular kind of EDI message. Today, these XSD, XDR and DTD files are stored as individual files that are used in connection with the validation and generation of EDI messages in an EDI system.

The process for generating instances of EDI documents based on EDI schema files today, however, is too rigid. As shown in FIG. 16B, an EDI schema 1620 is defined today according to a fixed structure, i.e., according to one or more TSDs, such as TSDs 1620a, 1620b and 1620c, which are explicitly defined within schema 1620, allowing no flexibility in the way that EDI documents 1630 are generated based on the schema 1620. Specifically, transaction sets 1630a, 1630b, 1630c of EDI document 1630 are generated in a way that conforms to the TSDs 1620a, 1620b and 1620c defined in EDI schema 1620.

Further, when an organization is maximizing the value of EDI messaging, the organization might have deployed countless schemas on behalf of the EDI system, and even numerous versions of the same schema, which are constantly evolving as business practices change, etc. Yet, today these pre-existing schema are not leveraged when Interchange schemas are created for incorporation into the EDI system. Instead, today, as mentioned, an EDI expert must generate the Interchange schema, which can be a tedious task particularly when multiple third parties are considered.

Such a task is difficult for the EDI system administrator for a variety of reasons. Understanding differences in transaction sets, TSDs and EDI data elements in general is difficult because it requires a thorough ability to read and understand schema in order for the system administrator to distill the formatting information necessary to create the schema elements. This is error prone because a user can never be sure all elements have been observed from a review of a sophisticated sample EDI document.

Accordingly, in consideration of the complexity, costs and lack of flexibility of the current state of the art of tools for generation or validation of EDI documents based on EDI schema, it would be desirable to provide improved tools for generating or validating EDI documents. These and other deficiencies in the state of the art of EDI systems will become apparent upon description of the various exemplary non-limiting embodiments of the invention set forth in more detail below.

### SUMMARY

In consideration of the foregoing, the invention provides improved EDI schema generation or EDI document formation based on extensible EDI schema, enhancing design time tools. In various non-limiting embodiments, the invention provides automatic schema discovery based on deployed schemas for transaction sets within the EDI. Instance generation and validation are also customizable to synchronize with per party EDI Properties enabling fine control over various choices for generation or validation processes.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the invention in a simplified form as a prelude to the more detailed description that follows.

### BRIEF DESCRIPTION OF THE DRAWINGS

The system and methods for generating or validating EDI documents in accordance with the present invention are further described with reference to the accompanying drawings in which:

FIGS. 1A and 1B are exemplary non-limiting block diagrams generally illustrating the improved EDI communications systems of the invention;

FIGS. 2A and 2B are exemplary non-limiting block diagrams generally illustrating automatic schema discovery in accordance with the invention;

FIG. 3 is an exemplary non-limiting flow diagram illustrating streamlined automatic processes for discovering schema for transaction sets of an Interchange in accordance with the invention;

FIG. 4 is an exemplary non-limiting block diagram illustrating the operation of per party options or rules applying to EDI instance generation and validation in accordance with the invention;

FIGS. 5A and 5B are exemplary non-limiting flow diagrams illustrating aspects of applying per party configurations to EDI document generation and validation processes in accordance with the invention;

FIGS. 6A, 6B, 7A, 7B, 8, 9, 10, 11 and 12 illustrate the operation of an exemplary, non-limiting tool in accordance with the invention via a series of screenshot user interfaces (UIs) illustrating, inter alia, the use of a lightweight or proxy schema that operates to automatically discover deployed schema for transaction sets of an Interchange;

FIG. 13 is an exemplary block diagram of a representative EDI communications system between a home organization having a server and trading partners of the home organization for supplemental context;

FIG. 14 is an exemplary block diagram of a representative EDI system including a hub and spoke architecture for supplemental context;

FIG. 15 is an exemplary block diagram representative of an interchange data structure including a plurality of EDI transactions for supplemental context;

FIGS. 16A and 16B are exemplary block diagrams representative of background regarding EDI schema and validation processes, which benefit from the improved EDI communication systems and methods provided in accordance with the invention;

FIG. 17 is a block diagram representing an exemplary non-limiting networked environment in which the present invention may be implemented; and

FIG. 18 is a block diagram representing an exemplary non-limiting computing system or operating environment in which the present invention may be implemented.

### DETAILED DESCRIPTION

### Overview

As mentioned in the background, the creation of EDI schema is currently too complicated due to the near limitless combination of transaction sets that may be included in the proposed EDI document. Since validation is currently a rigid process, the schema that is created should be able to handle all the combinations of EDI transaction sets that may appear in an EDI document, which can make for a complicated and difficult task for the schema designer.

Since a sample document may contain numerous transaction sets, the corresponding schema definition must take into account all of the various combinations of such transaction sets that may be received. In consideration of these problems with the current state of the art, the invention enables the creation of an EDI schema for validation based on deployed schema in an EDI system.

Instance generation is also customizable to synchronize with Per Party EDI Properties enabling fine control over various choices for validation processes. Exemplary rules or options that may be configured pertain to EDI vs. Extended validation based on deployed schema, selecting rules concerning delimiters used within an Interchange; acknowledgement (ACK) properties or requirements, rules pertaining to applied character sets, etc. In this regard, the invention enables a comprehensive design time support tool for Interchange/XML bounded input bounded output data collection and reporting (DCR) system.

### Extensible Schemas for Document Generation or Validation

As described in the background, today, when an EDI system receives a sample EDI document from a third party EDI system for proposed messaging between the EDI system and third party system, a rigid, exhaustively specified, Interchange schema is created to use for validating EDI documents of the proposed message type.

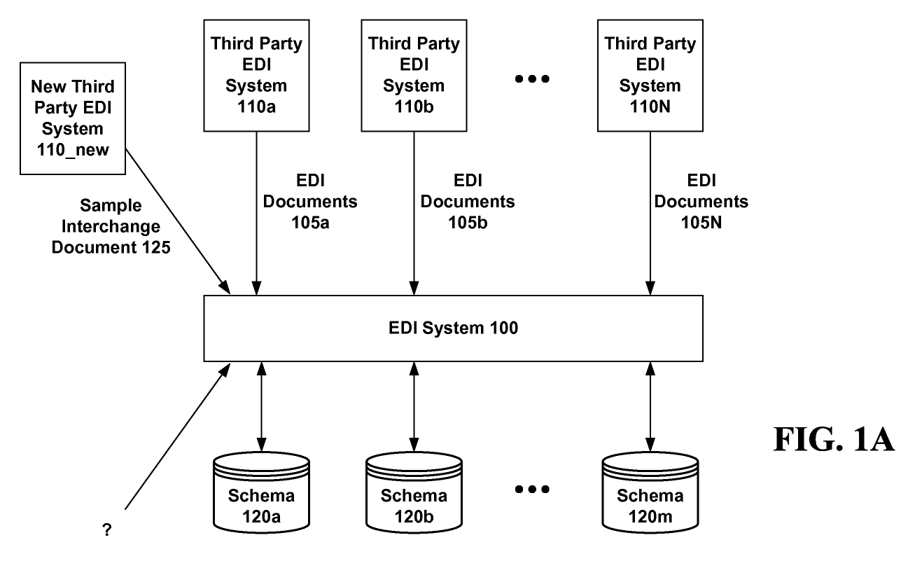

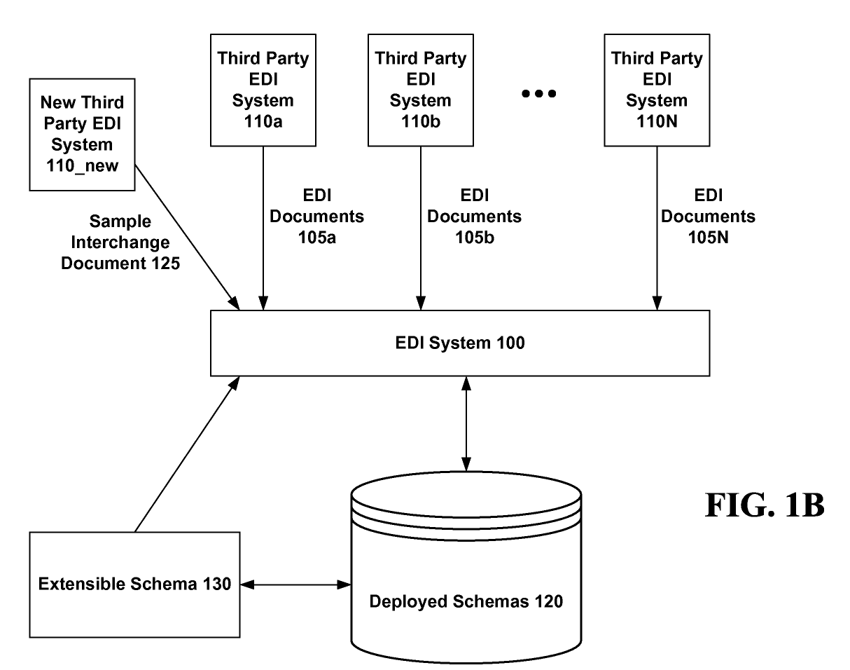

As shown in the simplified EDI system of FIG. 1A, typically, a (first party) EDI system 100 may receive EDI documents 105a, 105b, . . . , 105N from a variety of third party EDI systems 110a, 110b, . . . , 110N, respectively. To validate such EDI documents 105a, 105b, . . . , 105N, EDI system 100 consults any one or more of deployed schemas 120a, 120b, . . . , 120m to determine if one of the schemas 120a, 120b, . . . , 120m can be used to validate a received document. If there is no pre-existing EDI schema that is applicable, however, a schema must be created (as shown by the question mark) to validate such EDI/Interchange document and all of its different groupings of transaction sets that may be represented, as described in the background.

Advantageously, to address this situation, as shown in FIG. 1B, with the invention, an EDI schema is not required to explicitly include all transaction set definitions and their combinations. Instead, the invention operates to discover ‘deployed’ schemas, or TSDs deployed or otherwise accessible in the EDI system, without any requirement of hard association within a single document as in the past.

As shown in FIG. 1B, for instance, for a new sample Interchange document 125 received from a new third party 110_new, where no Interchange schema 120 exists for validating the Interchange document 125, the invention optionally enables a lightweight schema 130 to be created, which extends to relevant deployed schema of schemas 120 deployed in the EDI system (or subsystem). In this way, an EDI system administrator can opt to implicitly create lightweight schema 130 based on deployed EDI schemas 120 in the system. As described in more detail below, with the invention, an EDI system administrator can specify additional options to be performed when validating EDI documents as well, including rules or options that can be specified per third party.

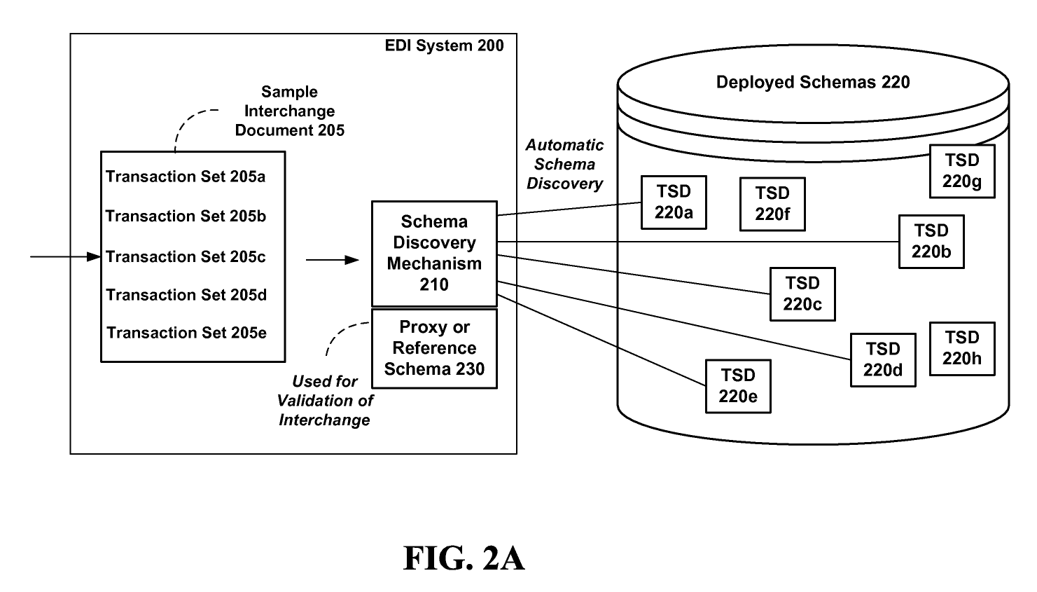

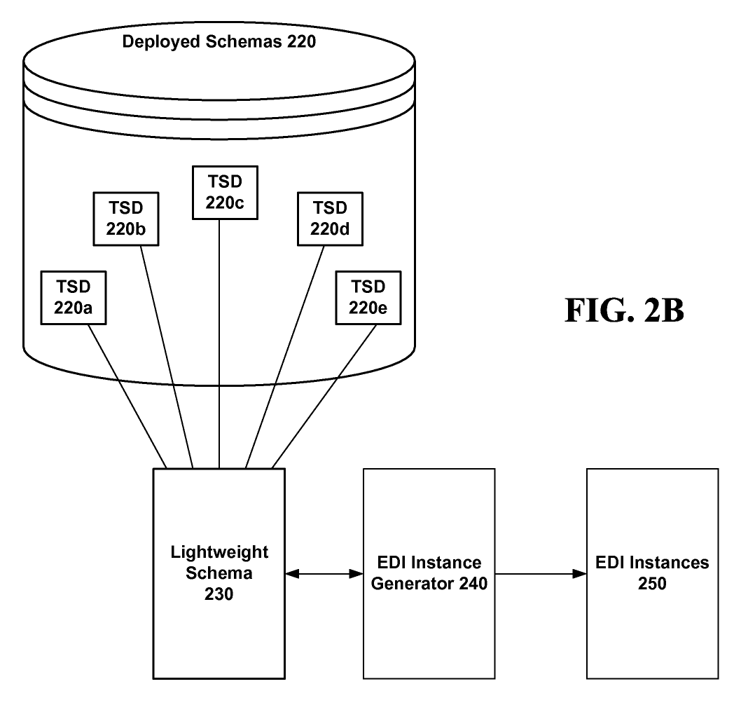

FIGS. 2A and 2B further illustrate the ability to validate EDI including different types of transaction sets without their definitions in a schema by discovering deployed schemas in assemblies without any hard association in accordance with the invention. As shown, EDI system 200 is to validate an Interchange document 205 including transaction sets 205a, 205b, 205c, 205d, 205e, etc. In accordance with the invention, a proxy, or reference, or lightweight schema 230 can be created which is used during validation by a schema discovery mechanism 210 provided in accordance with the invention to discover relevant deployed schemas 220. As shown, TSDs 220a, 220b, 220c, 220d, 220e. are discovered as relevant to validation of transaction sets 205a, 205b, 205c, 205d, 205e. TSDs 220f, 220g and 220h, while deployed, are not relevant to validation of any of the transaction sets 205a, 205b, 205c, 205d, 205e. In this fashion, some or all of document 205 can be validated against pre-existing schema without the need to explicitly and rigidly spell out a schema definition for the schema.

As shown in FIG. 2B, the lightweight or reference schema 230, which references TSDs 220a, 220b, 220c, 220d, 220e, can also be used by an EDI Instance generator 240 to generate EDI instances 250 without having a formal rigid definition of the schema.

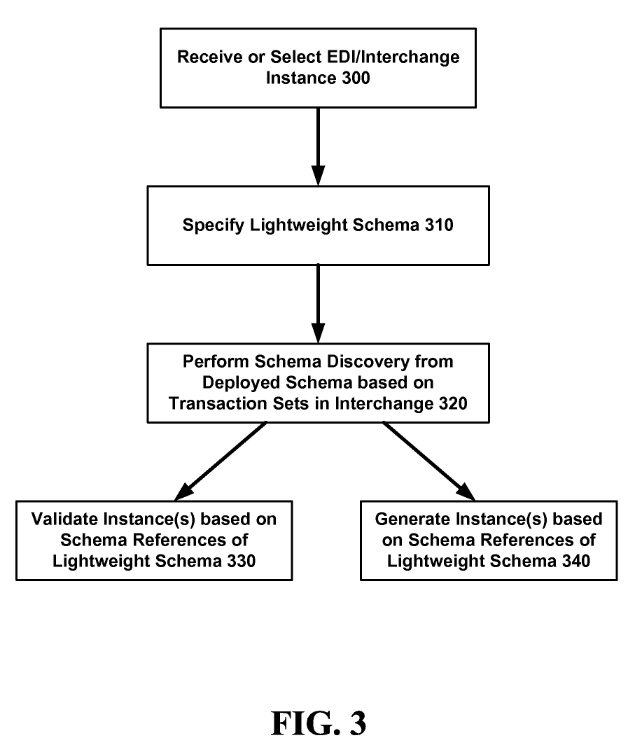

FIG. 3 is a flow diagram showing exemplary processes for using a lightweight reference schema in accordance with the invention. At 300, an EDI/Interchange instance is selected for which there is no pre-existing rigid schema file. At 310, a user specifies that the user wishes for automatic schema discovery to be performed, which includes creating a lightweight schema for referencing deployed schemas. At 320, the schema discovery from the deployed schema is performed for the types of transaction sets found in the EDI/Interchange instance. Based on the discovered schema, a user at 330 can further validate the instance based on the schema references of the lightweight schema or the user at 340 can generate other instance(s) based on the schema references of the lightweight schema.

Accordingly, in various non-limiting embodiments, the invention provides design time tools for EDI generation and/or validation, based on extensible schemas. This invention provides enhancement to the existing design time tools, which require the design of a complicated EDI/Interchange schema due to the limitless combinations of EDI transaction sets that may be included in the Interchange. The invention, inter alia, provides for automatic schema discovery based on deployed schemas within an EDI system, or one or more subsets of the EDI system. Automatic schema discovery provides significant improvement over the past approach of creating an overly complicated EDI/Interchange Schema/Definition to run during EDI/Instance validation.

In addition, the invention includes the ability to integrate with party configuration information and to use the configuration information to validate and/or generate EDI based on party settings that are in effect for each party. The invention enables customization of instance generation based on Party/EDI Properties enabling fine control over choice of the validation process, e.g., EDI Vs. Extended validation, choice of delimiters used within the interchange; ACK properties; applied character set(s), etc. An implementation includes providing a comprehensive design time support Interchange/XML bounded input bounded output DCR system.

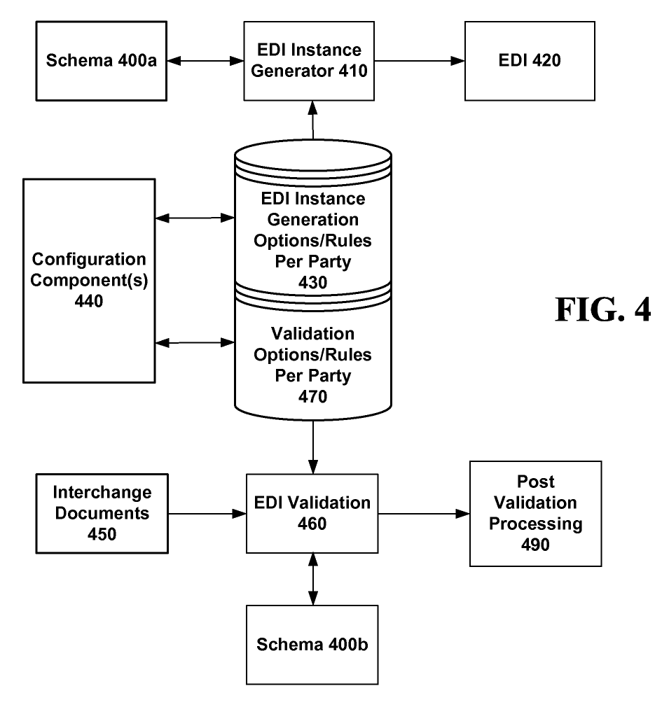

For instance, FIG. 4 is a block diagram of an exemplary non-limiting implementation of per party instance generation and validation options/rules in accordance with the invention. As illustrated, via one or more configuration component(s) 440, per party instance generation options/rules 430 and per party validation options/rules 470 can be defined for an EDI system. For instance, an EDI instance generator 410 generates EDI 420 based on a schema 400a, such as a lightweight schema defined in accordance with the above-described embodiments, according to per party EDI instance generation options/rules per part 430. On the validation side, an EDI Validation mechanism 460 validates Interchange documents 450 based on schema 400b according to validation options/rules per party 470. Once a document is validated, post validation processing 490 may occur in the EDI system.

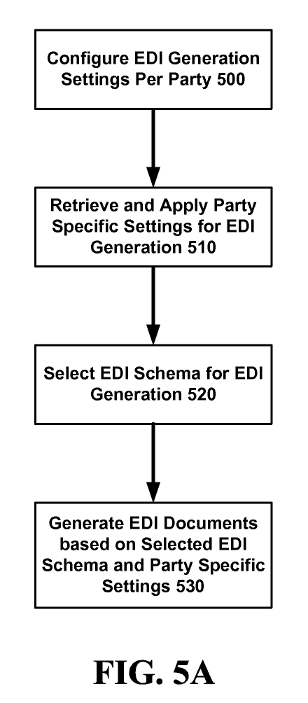

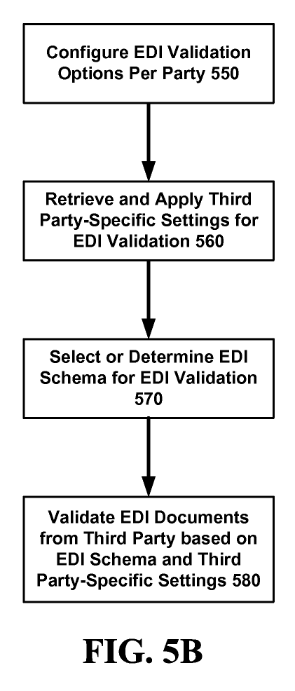

Exemplary processes for generating EDI based on per party settings is illustrated in the flow diagram of FIG. 5A. At 500, per party EDI generation settings are configured. At 510, party specific settings for EDI generation are retrieved and applied for a given EDI generation party context. At 520, an EDI schema, such as a lightweight schema defined in accordance with the invention, is selected for EDI generation to ensure that a valid document is generated. At 530, EDI documents are generated based on the selected EDI schema and party specific settings.

Exemplary processes for validating EDI based on per party settings is illustrated in the flow diagram of FIG. 5B. At 550, per party EDI validation settings are configured. At 560, party specific settings for EDI validation are retrieved and applied for a given EDI generation party context. At 570, an EDI schema, such as a lightweight schema defined in accordance with the invention, is selected for EDI document validation. At 580, EDI documents are validated based on the selected EDI schema and party specific settings.

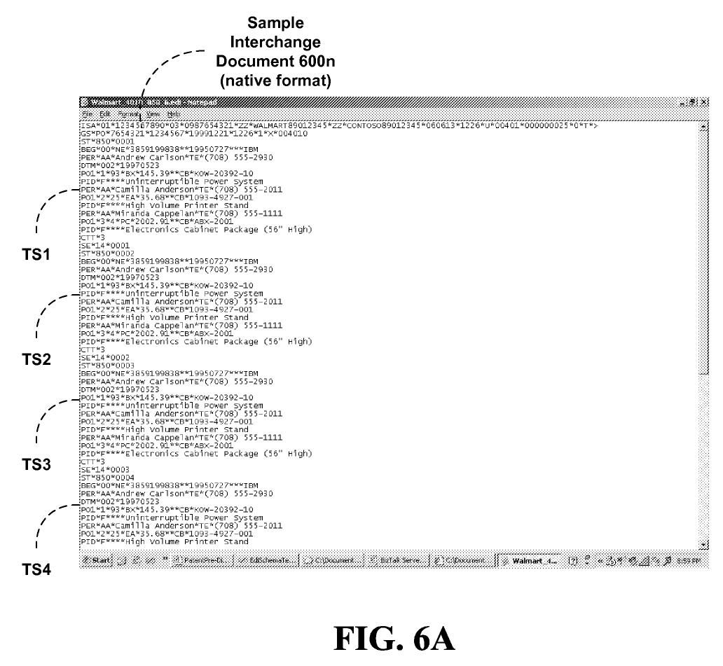

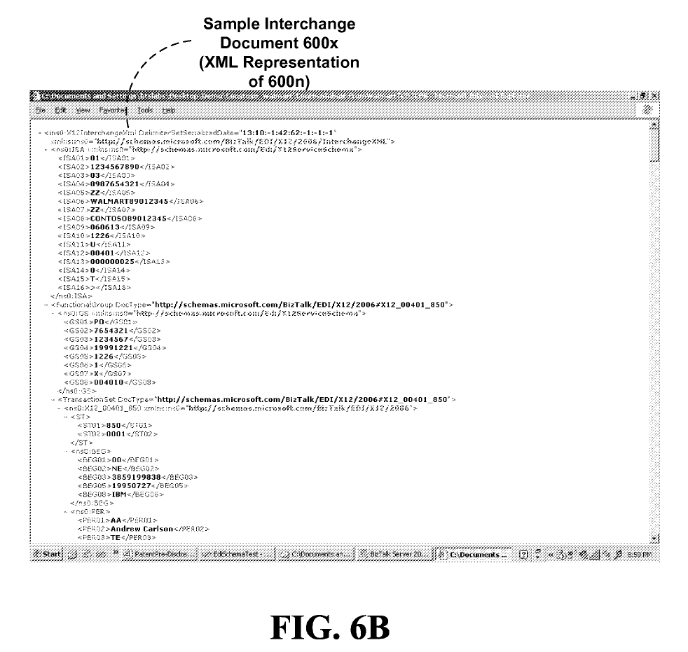

FIG. 6A displays an Interchange document 600n including various transaction sets TS1, TS2, TS3, TS4, etc. in native EDI encoding format. For an alternate view, FIG. 6B displays Interchange document 600n in XML encoding format 600x illustrating that EDI elements of Interchange document 600n can be translated to an XML representation 600x, and vice versa. To enable validation of such Interchange documents, as described in the background, today, users are required to create an XSD schema, which includes definitions for all transaction sets included in the Interchange document.

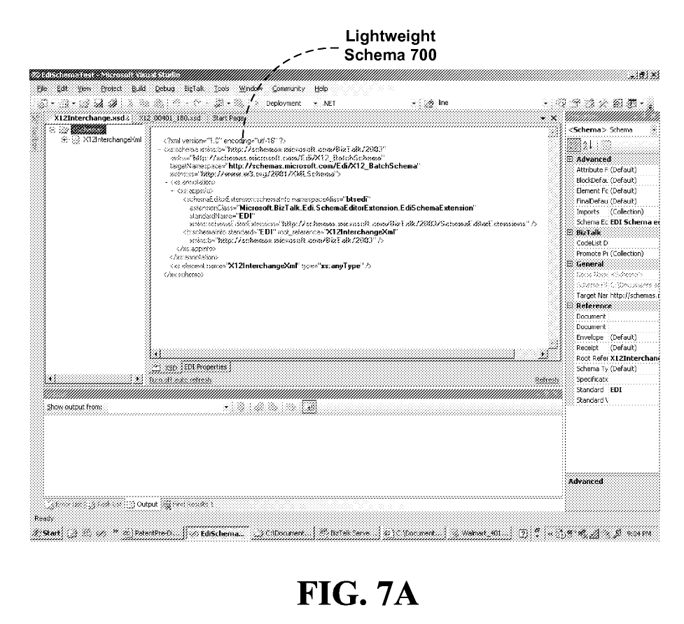

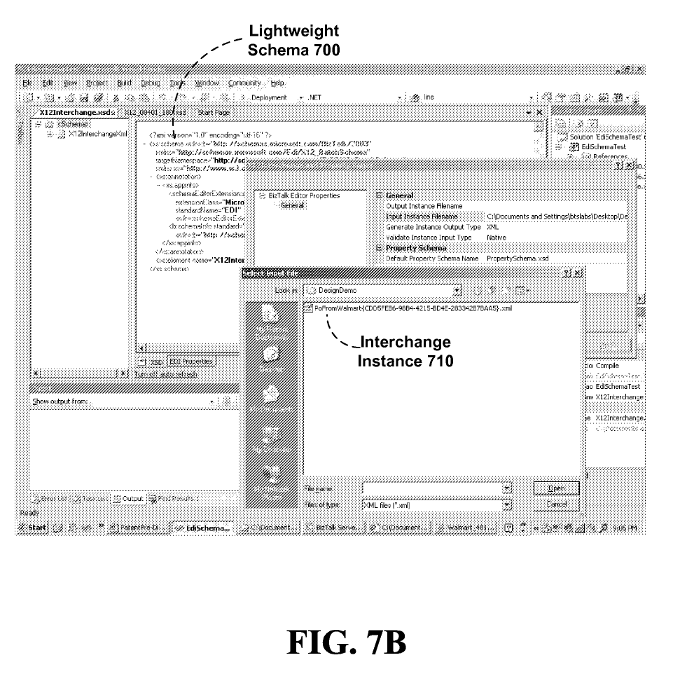

Advantageously, the invention addresses this issue by enabling validation of such EDI documents (EDI native format or XML encoded) without using a schema covering all types of transaction sets of a sample Interchange. Rather, in one embodiment, the invention substitutes a simple, or lightweight, Interchange schema 700 as displayed in the exemplary, non-limiting user interface of FIG. 7A. The lightweight Interchange schema 700 can then be used to validate EDI documents in conjunction with the techniques for automatic schema discovery from deployed schema within a defined target schema space in the EDI system.

Based on automatic discovery of relevant TSDs from deployed schema in a target namespace, FIG. 7B illustrates that lightweight schema 700 can be used in connection with the validation of other Interchange documents, such as Interchange instance 710, accessible to the EDI system. For instance, as shown in exemplary non-limiting fashion, using a properties window of a tool, the invention can be used to select EDI document instance 710 (e.g., a Walmart purchase order) without requiring an explicitly defined, self-contained schema definition as in the past. Based on EDI encoding rules, the invention determines the transaction types in the EDI and then, based on extensible references of lightweight schema 700, performs a look up of deployed schemas and upon encountering a match, references the match for later use in validation.

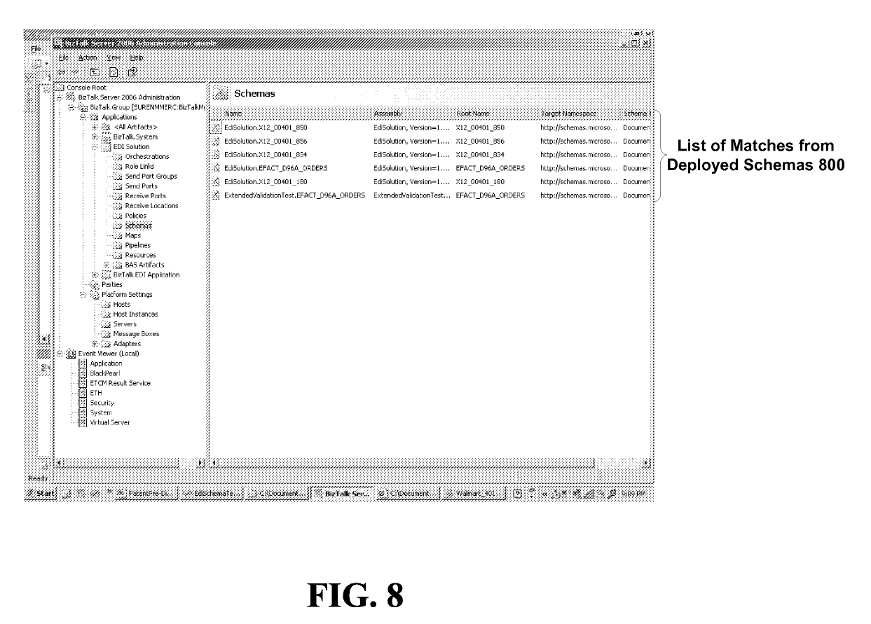

For illustrative purposes, in an exemplary non-limiting user interface, FIG. 8 shows a list 800 of the deployed schemas the invention uses for the validation process. List 800 is the list of deployed schemas that match the transaction set types found in EDI document instance 710 as a result of schema discovery in accordance with the invention. By referencing the list of schemas 800, the invention is able to validate EDI without requiring the generation of a complex schema. For instance, about 17 lines are included in lightweight schema 700 in contrast to the hundreds and thousands or more lines required of the complex schema of the past that explicitly covers all transaction types and groupings.

As mentioned, validation and EDI sample data generation can be based on party specific settings. For instance, in one embodiment, a party name is input by a user (e.g., Walmart) either explicitly or implicitly, and then the invention reads configuration information for that specific party. For instance, configuration information can be keyed into a data system by using trading partner manager application(s).

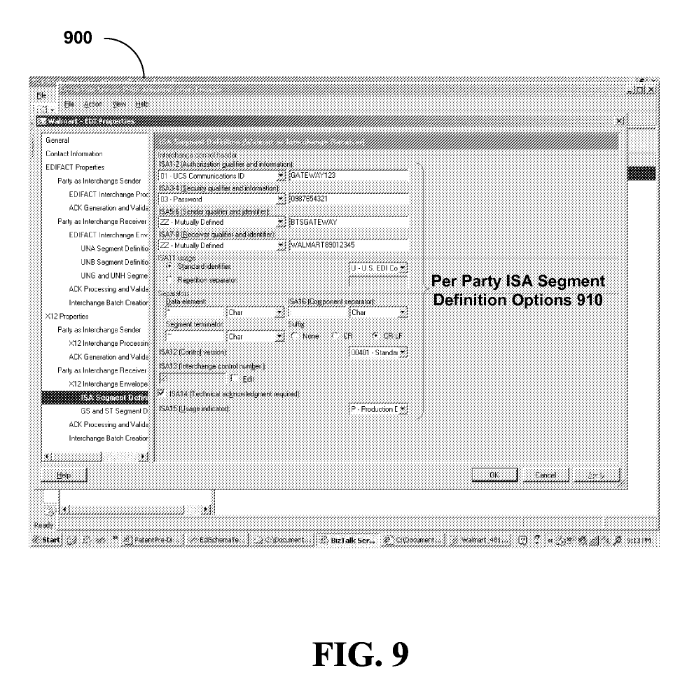

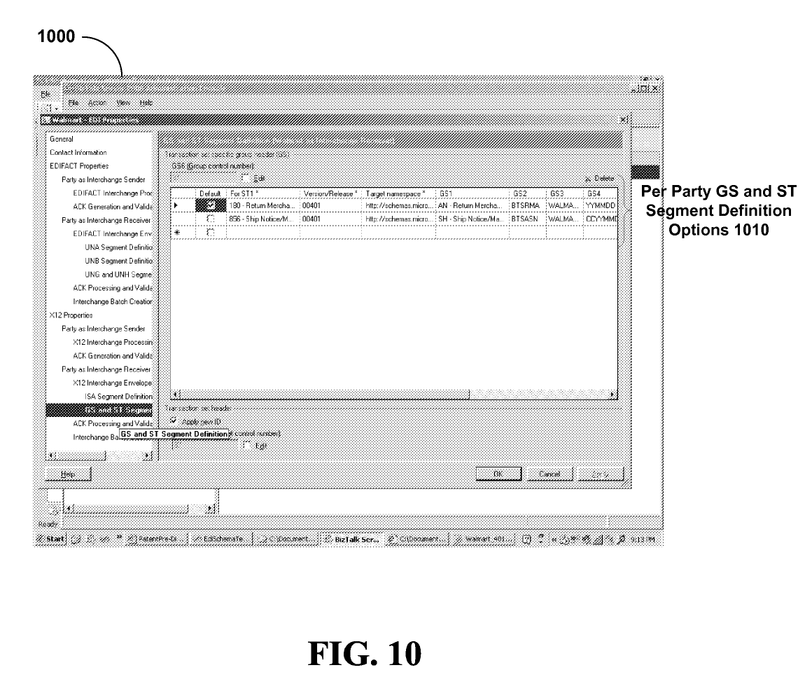

FIGS. 9 and 10 illustrate the provision of an exemplary non-limiting set of configuration information for a party. For instance, the exemplary non-limiting screenshot UI 900 of FIG. 9 shows ISA segment definition options/rules 910 that can be set on a per party basis. Similarly, the exemplary non-limiting screenshot UI 1000 of FIG. 10 shows GS and ST segment definition options/rules 1010 that can be set on a per party basis. Rather than defining such rules per TSD or Interchange schema, the settings apply to any EDI communications for an EDI system that involve a particular party.

Configuration information for specific parties, e.g., as shown in FIGS. 9 and 10, can be read in accordance with the invention to generate appropriate sample data, integrating the configuration process with the design process. As mentioned, without the invention, expert EDI users must hand craft the sample data.

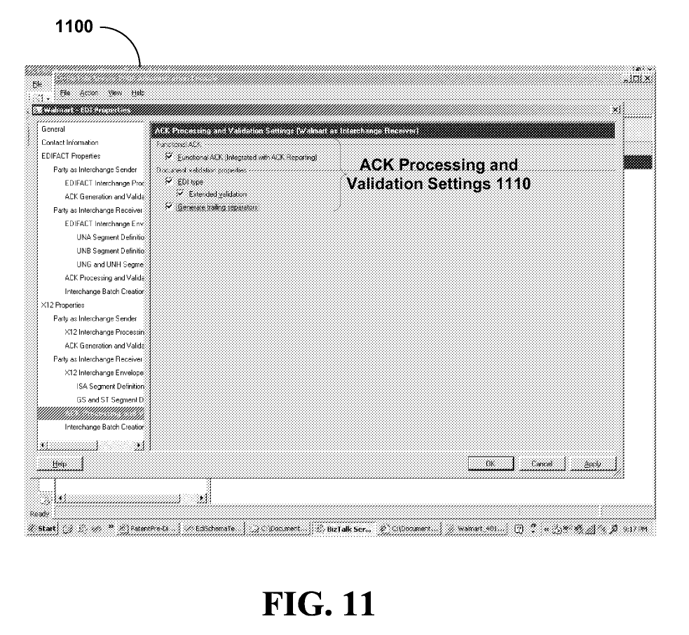

In accordance with the invention, validation of EDI is also made sensitive to party configurations. For instance, examples include the applicability of EDI and extended validation properties as described herein. For another example, if party settings do not require a certain validation, the invention stores such preference and acts accordingly when messaging (i.e., does not perform those validations). FIG. 11 displays exemplary non-limiting validation settings 1110 enabled for a party via screenshot UI 1100.

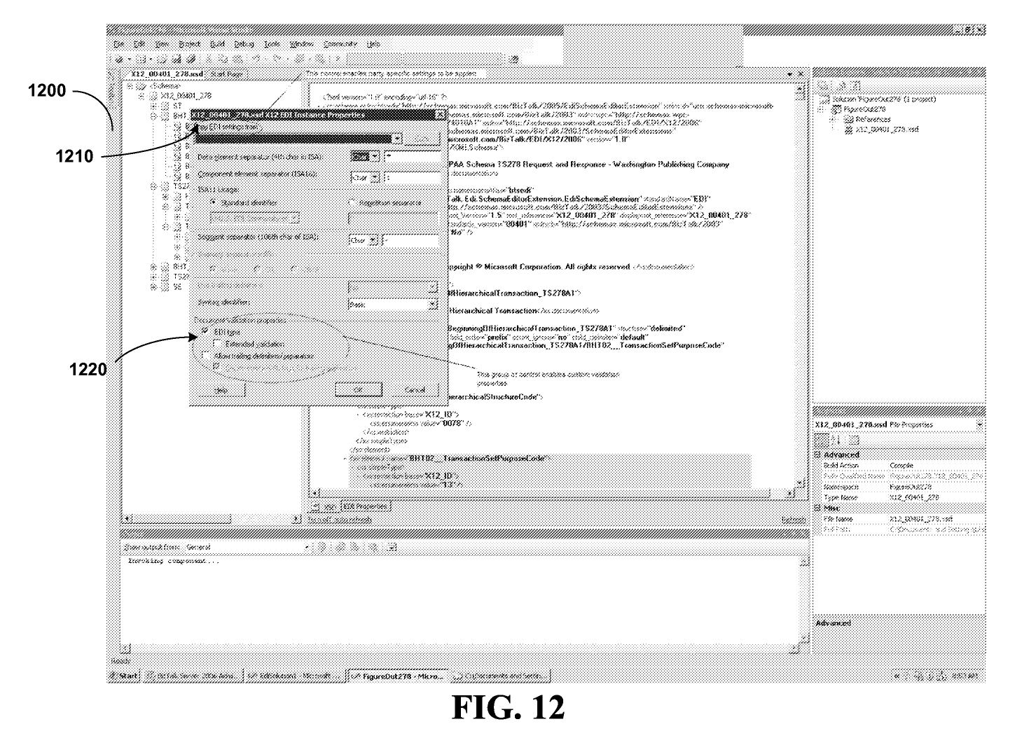

Via the exemplary screenshot UI 1200, FIG. 12 illustrates a control 1210 that allows party specific settings to be imported and applied. Alternatively, any time an EDI system knows a party is involved in a communication, that party's settings can be imported automatically. Additionally, FIG. 12 illustrates controls 1220 which may be used to configure or set document validation properties for a party.

Other exemplary rules or options that may be configured on a per party basis include, but are not limited to: EDI vs. Extended validation based on deployed schema, selecting rules concerning delimiters used within an Interchange; acknowledgement (ACK) properties or requirements, rules pertaining to applied character sets, etc. Accordingly, in various non-limiting embodiments described herein, the invention thus streamlines the integration of party configurations with an EDI document or schema development environment and further simplifies the schema requirements for design time activities.

### Supplemental Context Regarding EDI Messaging Systems

For supplemental context regarding EDI, EDI is the exchange of structured information, by agreed upon messaging standards, from one computer or computer application to another by electronic means with minimal human intervention. Based on approved formatting standards and schemas, EDI is one of the ways businesses exchange computer-to-computer business information. For example, millions of companies around the world transmit and store data associated with business transactions (e.g., purchase orders, shipping/air bills, invoices, or the like) using EDI to conduct commerce.

EDI may thus be defined as computer-to-computer exchange of business information using ‘approved’ formatting standards, referring to specific interchange methods agreed upon by national or international standards bodies for the transfer of business transaction data. One typical application for EDI messaging is the automated purchase of goods and services, though EDI messages are by no means limited to any particular kind of business data. In this regard, millions of companies around the world use EDI to conduct commerce. In raw format, EDI data is transmitted as delimited files (without self describing tags) and therefore the encoding rules enforce very strict formatting rules to ensure the destination application is able to successfully parse and consume the information for down stream processing.

In EDI terminology, organizations that send or receive documents from each other are referred to as “trading partners”. The trading partners agree on the specific information to be transmitted and how it should be used. Service providers provide global platforms (also known as trading grids) to connect and integrate “business partners” around the world. They provide integration platforms that make the exchange of EDI (or XML) documents transparent and easy between diverse constituents. These providers also track and reconcile documents to reduce errors and improve supply chain performance.

EDI translation software provides the interface between the internal system and the common standards and applies to both “inbound” documents and “outbound” documents. Translation software may also utilize other methods or file formats translated to or from EDI.

It can be appreciated by those of skill in the art that the structured information of EDI files can also be represented with the extensible markup language (XML), and vice versa. Despite the use of EDI being somewhat unheralded relative to its counterpart XML, EDI files are still the data format used in a majority of electronic commerce transactions in the world.

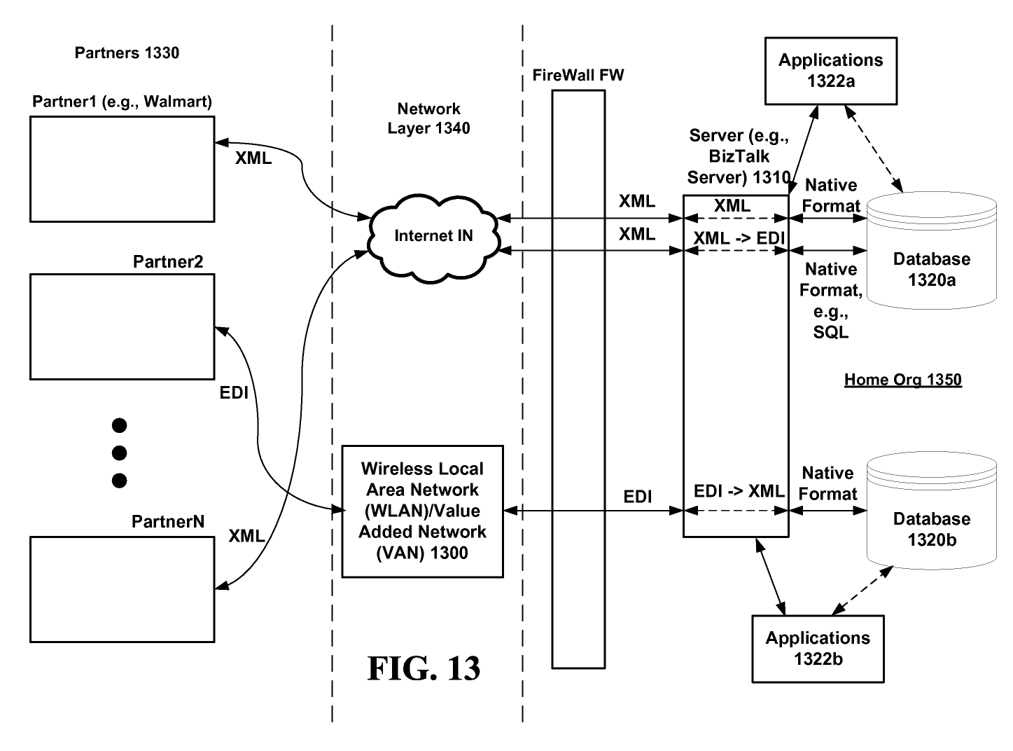

In the exemplary EDI system for a home organization 1350 shown in FIG. 13, typically server software 1310, such as Microsoft's BizTalk Server, can be deployed to interact outside of the home organization 1350 via network layer 1340 and to interface with databases 1320a, 1320b, etc. so that various applications 1322a, 1322b, etc., can interact with the automated storage of business records received by databases 1320a, 1320b, etc. EDI files or XML representations of EDI files can be received via Internet IN, or a wireless local area network (WLAN) or value added network (VAN) 1300 of network layer 1340, e.g., through firewall FW, and such EDI/XML messages can be received from any of a variety of trading partners 1330, i.e., partner1, partner2, . . . , partnerN. Server 1310 can handle any of the necessary conversions and parsing of EDI files or XML representations thereof, and any conversions to or from a native database format, such as SQL.

Typically, when EDI messages are received, a server receiving the EDI messages can answer in terms of an acknowledgment of receipt of the EDI messages to its trading partner. The server will specify whether the EDI message is invalid according to the schema, and if invalid, will specify why, or the server will specify that the EDI message was accepted, accepted with errors or rejected.

Internet IN has enabled EDI transactions to be transmitted between trading partners in an even more efficient manner. Internet IN provides business and government agencies with an environment that is open, fast, cost effective, and widely accepted and used.

VAN 1300 is a mechanism that facilitates the transfer of electronic data between trading partners. A VAN 1300 can be thought of as a post office, or a dedicated pipe, which allows an entity to send EDI formatted data to one of their trading partners at any time. The VAN 1300 will hold the file of transmitted transactions until the trading partner to whom it is addressed retrieves it at a later time.

EDI standards were designed to be independent of lower level technologies and can be transmitted using Internet protocols, such as the file transfer protocol (FTP), telnet and email, as well as private networks, such as value-added networks (VANs). EDI documents contain the same data that would normally be found in a paper document used for the same organizational function. For example, an EDI ship-from-warehouse order might be used by a manufacturer to tell a warehouse to ship product(s) to a retailer. It typically has a ship to address, bill to address, a list of product numbers (e.g., a UPC code) and quantities. It may also have other information if the parties agree to include it. However, EDI is not confined to just business data directly related to trade, rather but encompasses all fields such as medicine (patient records, laboratory results, etc.), transport (container and modal information, etc.), engineering and construction, etc., i.e., anywhere a first entity may wish to automate the exchange of data with another entity.

In a typical EDI transaction model, a large business entity or an EDI integration broker trades with numerous partners and has the technical capability to handle numerous EDI transaction data in various EDI formats and schemas. These entities, also known as “hubs,” transact with one or more suppliers, also known as “spokes.” Each of the spokes typically is a relatively small business entity that is only capable of dealing with one hub. Before the spokes attempt to initiate transactions via EDI with the hub, the hub typically transmits various EDI schemas to the spokes so that the spokes can properly format the EDI transactions according to the EDI schemas.

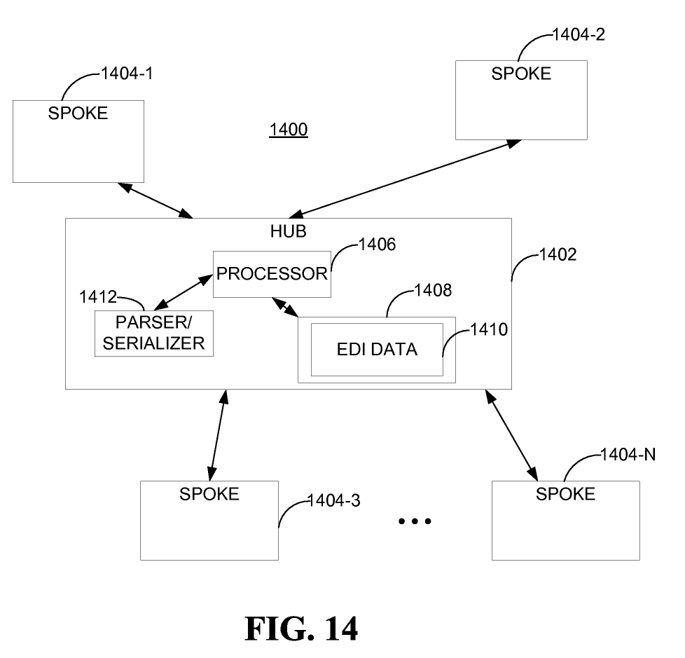

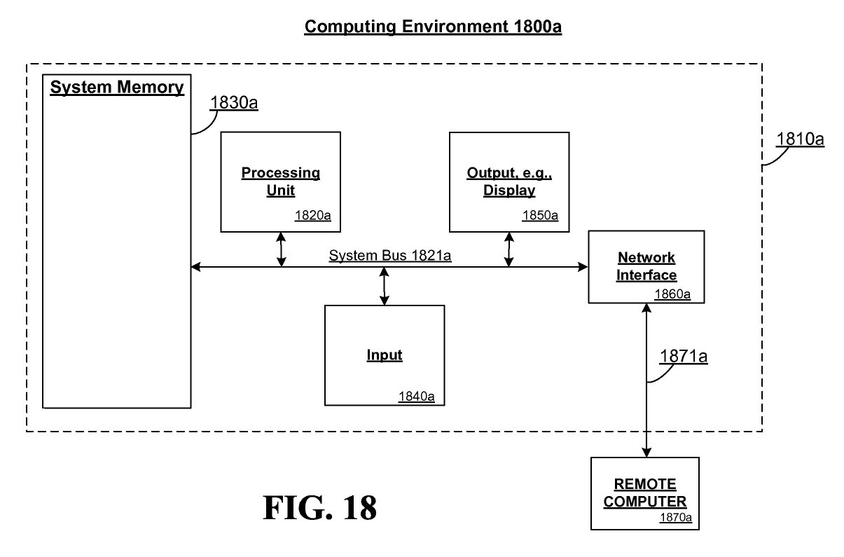

FIG. 14 is a block diagram illustrating a system for conducting EDI transactions according to exemplary non-limiting embodiments of the invention. A system 1400 is illustrated for conducting EDI transactions. System 1400 includes a hub 1402 linked to and communicating with one or more spokes (e.g., spokes 1404-1, 1404-2, 1404-3, . . . , 1404-N). In one embodiment, the hub 1402 includes a server computer or a computing device serving one or more processors (e.g., processor 1406) or processing units for executing computer-executable instructions for serving the spokes 1404. In one example, the spokes 1404 include a computing device, such as the computing device illustrated in FIG. 18, having one or more components included in or coupled with a computer 1430.

In one example, the hub 1402 also includes a memory area 1408 for storing one or more EDI schemas, such as an EDI schema 1410. Initially, the hub 1402 and the spokes 1404-1, 1404-2, 1404-3, . . . , 1404-N establish agreements as to the EDI formats or standards to be used for transmitting transaction data therebetween. Once the parties determine the particular EDI formats or standards to use, the hub 1402 selects the appropriate EDI schemas to be transmitted to the spokes 1404-1, 1404-2, 1404-3, . . . , 1404-N. In another example, the hub 1402 may choose to select all EDI schemas for all types of transactions, such as purchase orders, bills of lading, invoices, payrolls, or the like, to the spokes 1404-1, 1404-2, 1404-3, . . . , 1404-N.

Although the communications between the hub 1402 and the spokes 1404-1, 1404-2, 1404-3, . . . , 1404-N can be a private or public communications network, a wired or wireless network, the spokes 1404-1, 1404-2, 1404-3, . . . , 1404-N typically lack the hardware resources to handle large amount of EDI schemas sent from the hub 1402. In addition, the type and bandwidth of computing network communications for the spokes 1404-1, 1404-2, 1404-3, . . . , 1404-N are not equipped to handle such demand imposed by the thousands of EDI schemas, which can reach several Gigabytes in data size.

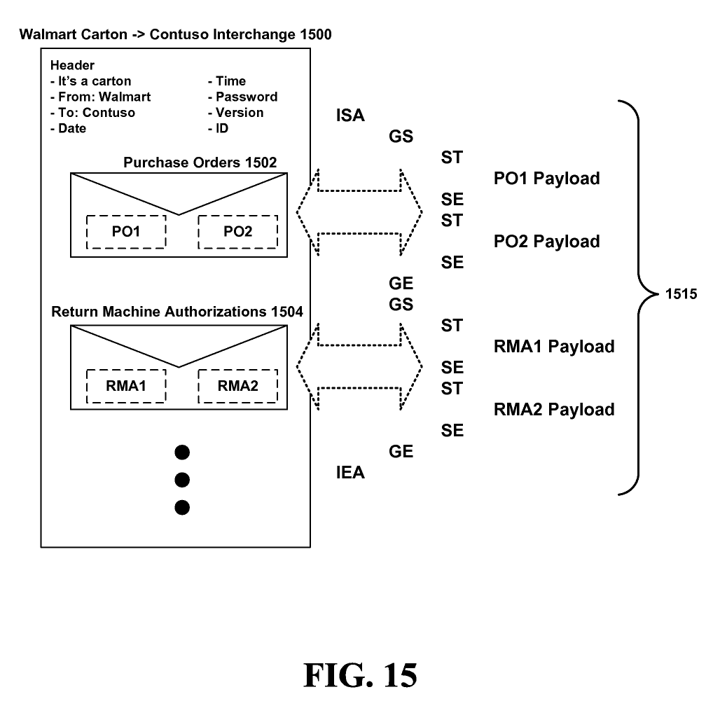

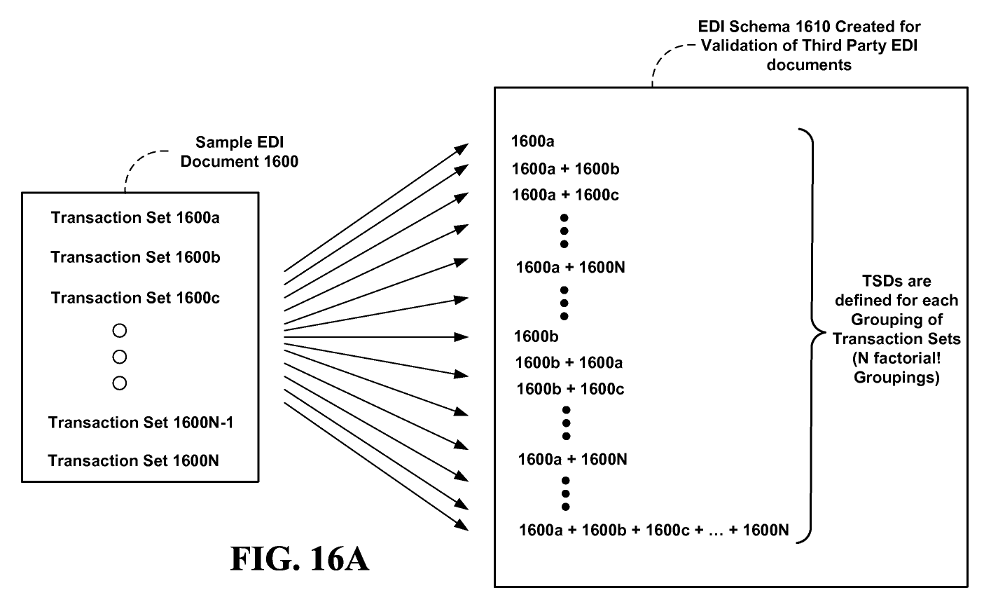

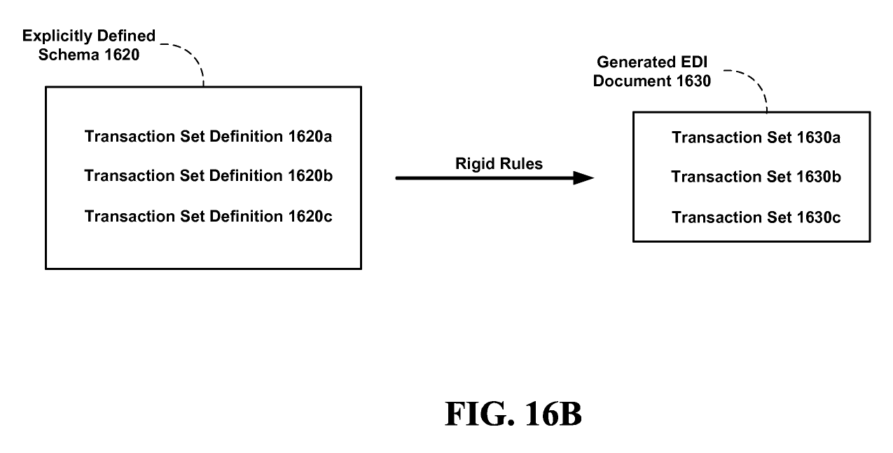

FIG. 15 in turn illustrates that an organization can generate an interchange 1500—a sort of carton for EDI messages—which includes a plurality of EDI messages. Interchange 1500 typically includes a header which includes a type of document, from whom the document originated, to whom the document is addressed, the date, the time, any password information, version information, identification information, and the like. Then the interchange 1500 lists a series of purchase orders 1502 and return machine authorizations (RMAs) 1504, conceptually shown as envelopes in the carton. In turn, each envelope conceptually represents one or more individual EDI files, or messages. For instance, purchase orders 1502 include individual purchase orders PO1 and PO2, and RMAs 1504 include RMAs RMA1 and RMA2, and so on.

In turn, there is a flat file native EDI format that corresponds to this conceptual relationship between carton->envelopes->messages. As illustrated by shell 1515 corresponding to the conceptual representation, the ISA<->IEA indent level represents the beginning and end of the interchange (carton). The GS and GE indent levels represent the beginning and end of any envelopes within the carton, and the ST and SE indent levels represent the beginning and end of any messages within an envelope, i.e., between any ST and SE will be an individual message payload, such as PO1 Payload, PO2 Payload, RMA1 Payload and RMA2 Payload.

There are several advantages of using EDI all of which provide distinct benefits to the user. One of the most notable benefits to using EDI is the timesaving capability it provides. By eliminating the process of distributing hard copies of information throughout the company, easy access to electronic data simplifies inter-department communication. In addition, another timesavings advantage is the ability to track the origin of all information therefore significantly reducing time spent on corresponding with the source of the information.

Another benefit for the user of this information system is the ultimate savings in costs for an organization. Although the initial set-up costs may seem high, the overall savings received in the long run ensures its value. For any business, regardless of its size, hard-copy print outs and document shipping costs add up. EDI allows for a paper-less exchange of information reducing handling costs and worker productivity that is involved with the organization of paper documents.

EDI has another strong advantage over paper-based information exchange, which has to do with accuracy of information. When the information is already stored electronically, it speeds up an organizations ability to check for accuracy and make any necessary corrections as the data is already input to the system. Also, unlike paper-based methods, EDI allows for the ability to send and receive information at any time thereby tremendously improving an organizations ability to communicate quickly and efficiently.

A disadvantage of using EDI involves the initial set-up. The preliminary expenses and time that arise from the implementation, customization and training can be costly. However, as EDI systems continue to improve, such as by using the batching membership evaluation techniques of the invention, such disadvantage is disappearing as ease of use increase.

### EDIFACT and X12 Standards for EDI Documents

There are two major sets of EDI standards which can be used to generate and receive/process EDI messages: the United Nations Electronic Data Interchange for Administration, Commerce and Transport, which is a translation of UN/EDIFACT (“EDIFACT”) and the American National Standards Institute's (ANSI) Accredited Standards Committee (ASC) X12 (“X12”). Both used worldwide, X12 tends to be more popular in North America than EDIFACT. These standards prescribe the formats, character sets, and data elements used in the exchange of documents and forms, such as invoices and purchase orders, e.g., purchase orders are called “ORDERS” in EDIFACT and “850s” in X12.

Whichever selected, the standard dictates which pieces of information are mandatory for a particular document, which pieces are optional and gives the rules for the structure of the document. In this regard, with optional pieces, two EDI documents can follow the same standard and contain different sets of information. For example, a food company might indicate a particular product expiration date while a clothing manufacturer might choose to send color and size information.

### Exemplary Networked and Distributed Environments

One of ordinary skill in the art can appreciate that the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with processes for generating or validating EDI documents based on extensible EDI schema in accordance with the present invention.

The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the systems and methods for generating or validating EDI documents based on extensible EDI schema in accordance with the present invention.

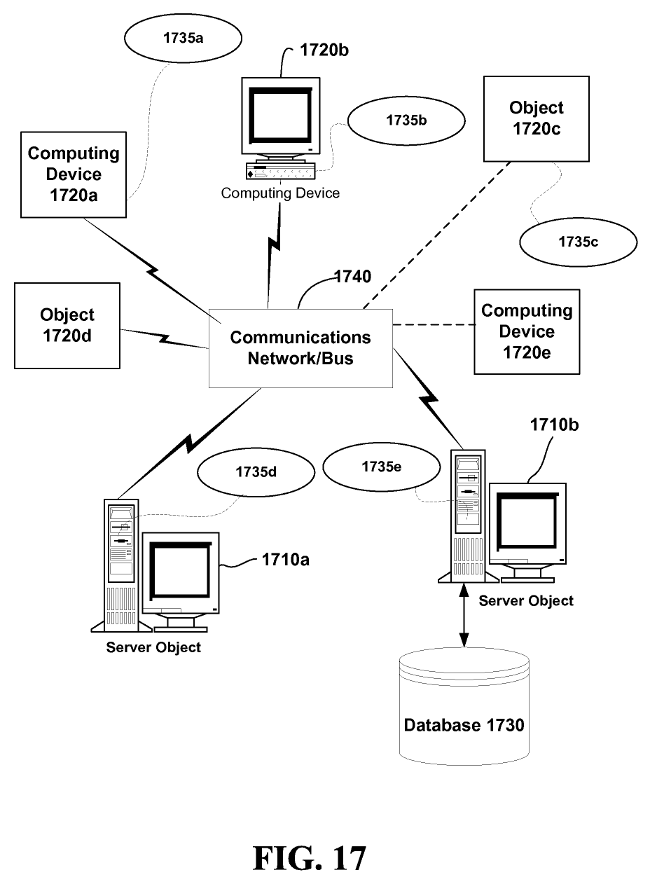

FIG. 17 provides a schematic diagram of an exemplary networked or distributed computing environment. The distributed computing environment comprises computing objects 1710a, 1710b, etc. and computing objects or devices 1720a, 1720b, 1720c, 1720d, 1720e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1740. This network may itself comprise other computing objects and computing devices that provide services to the system of FIG. 17, and may itself represent multiple interconnected networks. In accordance with an aspect of the invention, each object 1710a, 1710b, etc. or 1720a, 1720b, 1720c, 1720d, 1720e, etc. may contain an application that might make use of an API, or other object, software, firmware and/or hardware, suitable for use with the systems and methods for automatically updating schema maps in accordance with the invention.

It can also be appreciated that an object, such as 1720c, may be hosted on another computing device 1710a, 1710b, etc. or 1720a, 1720b, 1720c, 1720d, 1720e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to generating or validating EDI documents based on extensible EDI schema in accordance with the invention.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11 B) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge, or already have emerged, as protocol standards may be interconnected to form a network, such as an intranet, that may be connected to the outside world by way of a wide area network, such as the Internet. In short, a variety of disparate sources exist for the storage and transmission of data, and consequently, any of the computing devices of the present invention may share and communicate EDI messages and schema in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

A network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 17, as an example, computers 1720a, 1720b, 1720c, 1720d, 1720e, etc. can be thought of as clients and computers 1710a, 1710b, etc. can be thought of as servers although any computer can be considered a client, a server, or both, depending on the circumstances. Any of these computing devices may be processing data or requesting services or tasks that may implicate the systems and methods for generating or validating EDI documents based on extensible EDI schema in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for generating or validating EDI documents based on extensible EDI schema in accordance with the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 17 illustrates an exemplary networked or distributed environment, with server(s) in communication with client computer (s) via a network/bus, in which the present invention may be employed. In more detail, a number of servers 1710a, 1710b, etc. are interconnected via a communications network/bus 1740, which may be a LAN, WAN, intranet, GSM network, the Internet, etc., with a number of client or remote computing devices 1720a, 1720b, 1720c, 1720d, 1720e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to generate or validate EDI documents.

In a network environment in which the communications network/bus 1740 is the Internet, for example, the servers 1710a, 1710b, etc. can be Web servers with which the clients 1720a, 1720b, 1720c, 1720d, 1720e, etc. communicate via any of a number of known protocols such as HTTP. Servers 1710a, 1710b, etc. may also serve as clients 1720a, 1720b, 1720c, 1720d, 1720e, etc., as may be characteristic of a distributed computing environment.

As mentioned, communications may be wired or wireless, or a combination, where appropriate. Client devices 1720a, 1720b, 1720c, 1720d, 1720e, etc. may or may not communicate via communications network/bus 14, and may have independent communications associated therewith. For example, in the case of a TV or VCR, there may or may not be a networked aspect to the control thereof. Each client computer 1720a, 1720b, 1720c, 1720d, 1720e, etc. and server computer 1710a, 1710b, etc. may be equipped with various application program modules or objects 135a, 135b, 135c, etc. and with connections or access to various types of storage elements or objects, across which files or data streams may be stored or to which portion(s) of files or data streams may be downloaded, transmitted or migrated.

Any one or more of computers 1710a, 1710b, 1720a, 1720b, 1720c, 1720d, 1720e, etc. may be responsible for the maintenance and updating of a database 1730 or other storage element, such as a database or memory 1730 for storing data processed or saved according to the invention. Thus, the present invention can be utilized in a computer network environment having client computers 1720a, 1720b, 1720c, 1720d, 1720e, etc. that can access and interact with a computer network/bus 1740 and server computers 1710a, 1710b, etc. that may interact with client computers 1720a, 1720b, 1720c, 1720d, 1720e, etc. and other like devices, and databases 1730.

### Exemplary Computing Device

As mentioned, the invention applies to any device wherein it may be desirable to generate or validate EDI documents based on extensible schema. It should be understood, therefore, that handheld, portable and other computing devices and computing objects of all kinds are contemplated for use in connection with the present invention, i.e., anywhere that a device may include an EDI system or subsystem or otherwise receives, processes or stores EDI data or schema. Accordingly, the below general purpose remote computer described below in FIG. 18 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 18 thus illustrates an example of a suitable computing system environment 1800a in which the invention may be implemented, although as made clear above, the computing system environment 1800a is only one example of a suitable computing environment for a media device and is not intended to suggest any limitation as to the scope of use or functionality of the invention. Neither should the computing environment 1800a be interpreted as having any dependency or requirement relating to any one or combination of components illustrated in the exemplary operating environment 1800a.

With reference to FIG. 18, an exemplary remote device for implementing the invention includes a general purpose computing device in the form of a computer 1810a. Components of computer 1810a may include, but are not limited to, a processing unit 1820a, a system memory 1830a, and a system bus 1821a that couples various system components including the system memory to the processing unit 1820a. The system bus 1821a may be any of several types of bus structures including a memory bus or memory controller, a peripheral bus, and a local bus using any of a variety of bus architectures.

Computer 1810a typically includes a variety of computer readable media. Computer readable media can be any available media that can be accessed by computer 1810a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1810a. Communication media typically embodies computer readable instructions, data structures, program modules or other data in a modulated data signal such as a carrier wave or other transport mechanism and includes any information delivery media.

The system memory 1830a may include computer storage media in the form of volatile and/or nonvolatile memory such as read only memory (ROM) and/or random access memory (RAM). A basic input/output system (BIOS), containing the basic routines that help to transfer information between elements within computer 1810a, such as during start-up, may be stored in memory 1830a. Memory 1830a typically also contains data and/or program modules that are immediately accessible to and/or presently being operated on by processing unit 1820a. By way of example, and not limitation, memory 1830a may also include an operating system, application programs, other program modules, and program data.

The computer 1810a may also include other removable/non-removable, volatile/nonvolatile computer storage media. For example, computer 1810a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1821a through a non-removable memory interface such as an interface, and a magnetic disk drive or optical disk drive is typically connected to the system bus 1821a by a removable memory interface, such as an interface.

A user may enter commands and information into the computer 1810a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1820a through user input 1840a and associated interface(s) that are coupled to the system bus 1821a, but may be connected by other interface and bus structures, such as a parallel port, game port or a universal serial bus (USB). A graphics subsystem may also be connected to the system bus 1821a. A monitor or other type of display device is also connected to the system bus 1821a via an interface, such as output interface 1850a, which may in turn communicate with video memory. In addition to a monitor, computers may also include other peripheral output devices such as speakers and a printer, which may be connected through output interface 1850a.

The computer 1810a may operate in a networked or distributed environment using logical connections to one or more other remote computers, such as remote computer 1870a, which may in turn have media capabilities different from device 1810a. The remote computer 1870a may be a personal computer, a server, a router, a network PC, a peer device or other common network node, or any other remote media consumption or transmission device, and may include any or all of the elements described above relative to the computer 1810a. The logical connections depicted in FIG. 18 include a network 1871a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1810a is connected to the LAN 1871a through a network interface or adapter. When used in a WAN networking environment, the computer 1810a typically includes a communications component, such as a modem, or other means for establishing communications over the WAN, such as the Internet. A communications component, such as a modem, which may be internal or external, may be connected to the system bus 1821a via the user input interface of input 1840a, or other appropriate mechanism. In a networked environment, program modules depicted relative to the computer 1810a, or portions thereof, may be stored in a remote memory storage device. It will be appreciated that the network connections shown and described are exemplary and other means of establishing a communications link between the computers may be used.

### Exemplary Distributed Computing Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly browser or network-oriented.

For example, MICROSOFT®'s managed code platform, i.e., .NET, includes servers, building-block services, such as Web-based data storage and downloadable device software. Generally speaking, the .NET platform provides (1) the ability to make the entire range of computing devices work together and to have user information automatically updated and synchronized on all of them, (2) increased interactive capability for Web pages, enabled by greater use of XML rather than HTML, (3) online services that feature customized access and delivery of products and services to the user from a central starting point for the management of various applications, such as e-mail, for example, or software, such as Office .NET, (4) centralized data storage, which increases efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform and language integration features as well.

While some exemplary embodiments herein are described in connection with software, such as an application programming interface (API), residing on a computing device, one or more portions of the invention may also be implemented via an operating system, or a “middle man” object, a control object, hardware, firmware, intermediate language instructions or objects, etc., such that the methods for generating or validating EDI documents based on extensible schema in accordance with the invention may be included in, supported in or accessed via all of the languages and services enabled by managed code, such as .NET code, and in other distributed computing frameworks as well.

There are thus multiple ways of implementing the present invention, e.g., an appropriate API, tool kit, driver code, operating system, control, standalone or downloadable software object, etc. which enables applications and services to use the systems and methods for generating or validating EDI documents based on extensible schema in accordance with the invention. The invention contemplates the use of the invention from the standpoint of an API (or other software object), as well as from a software or hardware object that receives schema changes that occur in a computing system implicating the systems and methods for generating or validating EDI documents based on extensible schema in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to generate or validate EDI documents based on extensible schema. For instance, the invention can be implemented as a design time application or tool that enables validation and/or generation of EDI documents based on extensible schema, but may also be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device.

One or more programs that may implement or utilize the techniques for generating or validating EDI documents based on extensible schema in accordance with the invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of FIGS. 3, 5A and 5B. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide methods for generating or validating EDI documents based on extensible schema in accordance with the invention. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for use in an electronic data interchange (EDI) communications system, comprising:
receiving information representative of at least one interchange of an EDI system including a plurality of different types of transaction sets; and
automatically discovering at least one deployed EDI schema in the EDI system that corresponds to at least one of the plurality of different types of transactions sets.

2. The method of claim 1, further including:
validating the at least one interchange based on the at least one deployed EDI schema discovered according to the discovering step.

3. The method of claim 2, wherein said validating includes validating the at least one interchange according to configuration settings specific to a party originating the at least one interchange.

4. The method of claim 2, further comprising:
inputting configuration settings specific to a party originating the at least one interchange to be used during said validating step.

5. The method of claim 1, further including:
generating a reference schema that references the at least one deployed EDI schema discovered during said discovering step.

6. The method of claim 5, further including:
authoring at least one EDI document based on the reference schema generated during said at generating step.

7. The method of claim 5, wherein said generating includes generating a reference schema that references at least one transaction set definition (TSD) deployed in the EDI system.

8. The method of claim 1, wherein said discovering includes automatically discovering at least one deployed EDI schema stored in a relational format of a relational database system.

9. A computer readable medium comprising computer executable instructions for performing the method of claim 1.

10. A computing device comprising means for performing the method of claim 1.

11. A user interface for use in connection with an electronic data interchange (EDI) communications system for communication of EDI documents between EDI parties, comprising:
a party configuration user interface component that receives a specification of at least one option specific to an EDI party of the EDI system for use when at least one of validating or generating an EDI document instance in the EDI system pertaining to the EDI party; and
a configuration application component that applies the at least one option to performing at least one of validation of EDI document instances pertaining to the EDI party or generation of EDI document instances pertaining to the EDI party.

12. The user interface of claim 11, wherein the at least one option specific to an EDI party includes an option that validates at least one interchange automatically based on at least one deployed EDI transaction set definition (TSD) in the EDI system.

13. The user interface of claim 11, wherein the at least one option specific to an EDI party includes an option that specifies definition rules for ISA segments of an EDI document associated with the EDI party.

14. The user interface of claim 11, wherein the at least one option specific to an EDI party includes an option that specifies definition rules for at least one of GS segments or ST segments of an EDI document associated with the EDI party.

15. The user interface of claim 11, wherein the at least one option specific to an EDI party includes an option that specifies the EDI party does not require validation in a defined EDI messaging context.

16. The user interface of claim 11, wherein the at least one option specific to an EDI party includes at least one of an option to perform extended validation based on deployed schema, an option to select rules concerning delimiters used within an Interchange, an option to specify acknowledgement (ACK) properties and an option to select rules pertaining to applied character sets.

17. A server object for interfacing with at least one data store that stores a plurality of electronic data interchange (EDI) transaction set definitions (TSDs), including:
an EDI document processing component that receives information representative of at least one interchange of an electronic data interchange (EDI) system including a plurality of different types of transaction sets; and
an automatic schema discovery component that automatically discovers at least one deployed TSD of the plurality of EDI TSDs that correspond to at least one of the plurality of different types of transactions sets.

18. The server object of claim 17, further including:
a validation component that validates the at least one interchange based on the at least one deployed TSD discovered by the automatic schema discovery component.

19. The server object of claim 17, further including:
a tool for generating at least one EDI document based on a reference schema that references the at least one deployed TSD discovered by the automatic schema discovery component.

20. The server object of claim 17, further including:
a party configuration component that receives settings for at least one option specific to an EDI party of the EDI system for use when at least one of validating or generating an EDI document instance in the EDI system pertaining to the EDI party.
